(19) United States
(12) Patent Application Publication
(10) Pub. No.: US 2010/0082883 A1
(43) Pub. Date: Apr. 1, 2010

(54) Hybrid density memory system and control method thereof

(76) Inventors: Ming-Dar Chen, Hsinchu City (TW); Tso-Cheng Su, Taipei City (TW); Shih-Fang Hung, Yonghe City (TW); Tzu-Wei Fang, Jhonghe City (TW); Hsiang-An Hsieh, Sijhih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/379,698

(22) Filed: Feb. 26, 2009

(30) Foreign Application Priority Data
Oct. 1, 2008 (TW) 97137700

(51) Int. Cl. G06F 12/02

(52) U.S. Cl. 711/103; 711/E12.008

(57) ABSTRACT

A control method of a memory system for accessing an updated data between a host and the memory system is provided. The host has storage space which is divided into a plurality of logical segments to access the data. The system includes a high density memory and a low density memory, and the high density memory includes a plurality of physical segments to access the data. The control method includes the following steps: first, providing a LDM table in the memory system to indicate the allocation information of the low density memory; finally, deciding where the data is written to is according to its properties and the LDM table.

### BACKGROUND OF THE INVENTION

1. Field of the Invention

The present invention relates to a storage device; in particular, to a hybrid density memory system and control method thereof.

2. Description of Related Art

Non-volatile memory is applied on various data storage applications; taking Flash memory for example, it is commonly used as a storage device such as memory card, USB interface, thumb disc, solid state drive etc.

Refer initially to FIG. 1, which shows a system architecture diagram of an embodiment for a conventional memory system. As depicted in FIG. 1, the memory system 13 may be coupled to a host 11, allowing data access between the host 11 and the memory system 13. In the host 11, the position where the data is stored is indicated by a logical address, while in the memory system 13 such a position is expressed by a physical address. The memory system 13 comprises a storage module 131 and a control module 133. The said storage module 131 is used to store data, and when the host 11 intends to access data stored in the storage module 131, the control module 133 converts the logical address of the data issued by the host 13 into the corresponding physical address in the storage module 131, thereby enabling correct data access operations.

Since the range of the said logical address and physical address may be extremely wide, it could be thus time-consuming to convert the logical address into the specific physical address; as a result, currently available memory system 13 employs the concept of segmentation to divide the storage module 131 into a plurality of physical segments, and the storage space provided inside the host 11 is also partitioned into a plurality of one-to-one corresponding logical segments, with each physical segment further consisting of multiple blocks, each physical block yet further including multiple addresses, such that it is possible to use the block as a unit to map between the logical and physical addresses, further providing convenient management of storage space in the memory.

Refer now to FIG. 2, wherein an embodiment of the concept for conventional logical/physical address conversion is shown. As depicted in FIG. 2, after required computations, the logical addresses of storage space in the host 11 are divided into 8000 Logical Block Addresses (LBAs), with every 250 logical blocks sequentially grouped in unit to define the range of a logical segment, further obtaining 32 logical segments LS₀, LS₁, . . . , LS₃₁. Meanwhile, the storage module 131 in the memory system 13 is also partitioned into 32 physical blocks PS₀, PS₁, . . . , PS₃₁ based on the same concept, each physical block having 256 continuous Physical Block Addresses (PBAs), wherein 250 physical blocks map to the logical blocks individually, and the rest 6 physical blocks are free blocks for backup purpose, in order to record control data or to replace bad physical blocks.

In the memory system 13 there stores a Logical/Physical Mapping Table (L2P Mapping Table) in the free block, which records the conversion correspondence between the physical block and the logical block in each physical segment; in practice, the logical segment LS₀ records logical addresses 0˜63999, which is divided into 250 logical blocks (LBA=0˜249), the L2P Mapping Table records the correspondence between the 250 logical blocks and the physical blocks PBA=0˜255. Hence, through the L2P Mapping Table, it may quickly map the logical address to the correct physical address.

From the aforementioned descriptions, it can be seen that, although the number of memory unit conversions is reduced thanks to the concept of segmentation, avoiding the requirement for providing large amount of storage space to store the L2P Mapping Table, however, an effective method of data allocation for current hybrid memory system architecture consisting of high density memory and low density memory is unfortunately not provided. Since the high density memory and the low density memory respectively has different numbers of erasure endurance, if data is simply arbitrarily allocated in these two types of memories, it tends to cause uneven number of erasure endurances in these two types of memories. As a result, it is inevitable to encounter a situation that the memory of one density may reach first the limit for its number of endurance, while the other one is still usable, thus causing undesirable early ending of lifespan in the storage device.

### SUMMARY OF THE INVENTION

Accordingly, the present invention provides a control method for hybrid density memory system which allocates data at the memory of different density based on data properties, and also provides an effective management method for data storage in the hybrid density memory, so as to achieve the objective of wear-leveling, improving lifespan of the memory system.

Therefore, the objective of the present invention is to provide a hybrid density memory system and control method thereof, allowing to achieve the objective of wear-leveling in allocating user data to the memory, so as to further increase memory system lifespan and prevent unnecessary waste of storage resources.

Another objective of the present invention is to provide a hybrid density memory system and control method thereof, enabling effective management of the memory data in allocating user data to the memory, further enhancing the data storage performance of the memory system.

The present invention also discloses a hybrid density memory system which is applicable to allow a host to access user data. The said hybrid density memory system comprises a storage module and control module. The addressing interval in the control module regarding to the host accessing the user data consists of a plurality of logical units. The storage module consists of a high density memory unit formed by high density memories and a low density memory unit formed by low density memories, wherein the high density memory unit is divided into a plurality of physical units as the storage space to facilitate one-to-one correspondence with such logical units, with each physical unit including a plurality of physical blocks. The control module is coupled between the host and the storage module, used to transfer the user data to the high density memory unit or the low density memory unit based on the properties of the user data.

In one embodiment of the present invention, the said logical unit is a logical segment, while the physical unit is a physical segment. Meanwhile, each physical unit has a Segment Table indicating the allocation information about the included physical blocks therein. The Segment Table particularly has an update field indicating the address in the low density memory unit for accessing the user data.

In one embodiment of the present invention, the said low density memory unit has a Low Density Memory table (LDM table) indicating the allocation information about the storage space in the low density memory unit; and the address of the LDM table is recorded in the Segment Table.

The present invention also discloses a control method for the hybrid density memory system applicable for user data access between a host and the hybrid density memory system, wherein the host has a plurality of logical units as the storage space for user data accesses, and the hybrid density memory system has a high density memory unit and a low density memory unit, which high density memory unit providing a plurality of physical units as the storage space to one-to-one correspond to the logical units, each physical unit including a plurality of physical blocks. The steps for the said control method comprise, initially, providing a Low Density Memory table (LDM table) in the hybrid density memory system to record the allocation information about the storage space of the low density memory unit; secondly, transferring the user data to the high density memory unit or the low density memory unit based on the properties of the user data and the contents of the LDM table.

Through the aforementioned technical solutions, the present invention is able to allocate the data to suitable memory space according to the properties of data, recycling the use of the storage space mechanism, further providing the effect of wear-leveling

The summary illustrated hereinbefore as well as the following detailed descriptions and appended drawings are all for further setting forth the measures, means and effects taken by the present invention to achieve the prescribed objectives. Other purposes and advantages related to the present invention will be thoroughly explained in the subsequent descriptions and appended drawings as well.

### BRIEF DESCRIPTION OF THE DRAWINGS

FIG. 1 shows a system architecture diagram of an embodiment for a conventional memory system;

FIG. 2 shows an embodiment of the concept for the conventional segmentation logical/physical address conversion;

FIG. 3 shows a system architecture diagram of an embodiment for the hybrid density memory system according to the present invention;

FIG. 4 shows a storage architecture diagram of an embodiment for the logical/physical segment mapping according to the present invention;

FIG. 5 shows an architecture diagram of an embodiment for the master table according to the present invention;

FIG. 6 shows an architecture diagram of an embodiment for the Segment Table according to the present invention;

FIG. 7 shows an architecture diagram of an embodiment for the Low Density Memory table according to the present invention;

FIGS. 8A˜8D show diagrams of an embodiment for the data processes according to the present invention;

FIGS. 9-1, 9-2 show a stepwise flowchart of an embodiment for the control method of the hybrid density memory system according to the present invention; and

FIG. 9-3 shows a stepwise flowchart of an embodiment for the block recycling process applicable for the low density memory unit of the present invention, according to the present invention.

### DETAILED DESCRIPTION OF PREFERRED EMBODIMENTS

The present invention provides a hybrid density memory system and control method thereof, which, under the architecture of segmented memory management, is allowed to allocate the user data to low density memory or the high density memory based on the properties of the user data, and also provides a method for processing the data allocated to these two types of memories as well as a mechanism for wear-leveling, so as to improve the effectiveness of use and lifespan in the hybrid density memory system.

The essential technical characteristics of the present invention lie in the control method for wear-leveling operations in the hybrid density memory system and the memory system architecture employing the disclosed method; while the following texts provide the necessary internal system architecture and operation flows thereof, those skilled ones in the art can, however, appreciate that, except the said elements illustrated hereinafter, the memory system may certainly comprise other required components as desired. Therefore, it is not intended to be limited by the disclosed embodiments of the present invention.

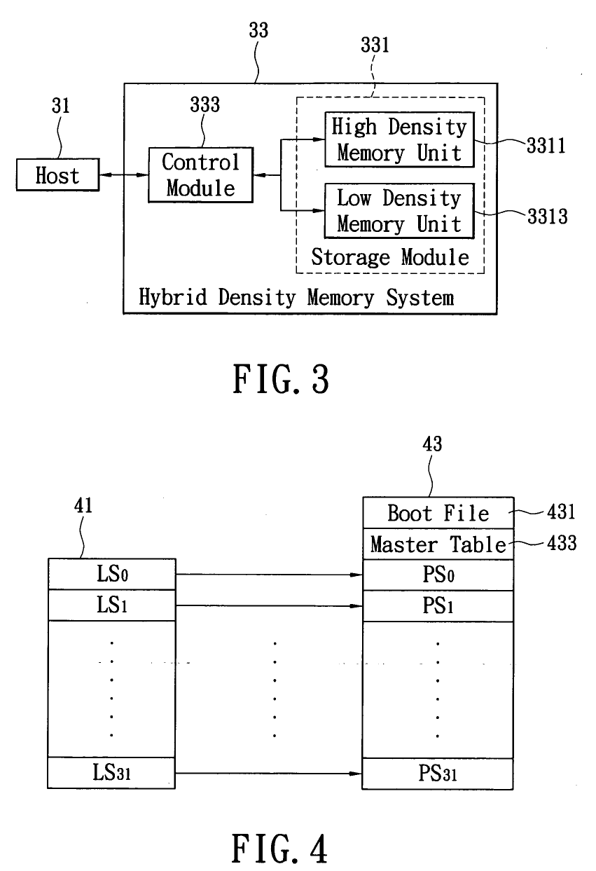

Initially, refer to FIG. 3, wherein a system architecture diagram of an embodiment for the hybrid density memory system according to the present invention is shown. As depicted in FIG. 3, the hybrid density memory system 33 (hereunder generally referred as the memory system) is coupled to a host 31, receiving commands from the host 31 to perform read or write operations on the data (hereunder generally referred as the user data) to which the command corresponds.

The memory system 33 comprises a storage module 331 and a control module 333. The storage module 331 consists of a high density memory unit 3311 formed by high density memories and a low density memory unit 3313 formed by low density memories for storing the user data; the control module 333 is coupled between the host 31 and the storage module 331 to receive the command issued by the host 31. Herein the operation modes of the host 31 include a read mode and a write mode, respectively issuing a read command and a write command to the memory system 33, in which the write command writes the user data corresponding to a logical address to the storage module 331, and the read command reads out the user data corresponding to a logical address from the storage module 331.

In one embodiment according to the present invention, the said storage module 331 is composed of non-volatile memories, herein the low density memory unit 3313 may be Single-Level Cell (SLC) memory, Phase-Changed Memory (PCM), free Ferro-electronic Random Access Memory (FeRAM) or Magnetic Random Access Memory (MRAM); the high density memory unit 3311 may be Multi-Level Cell (MLC) memory.

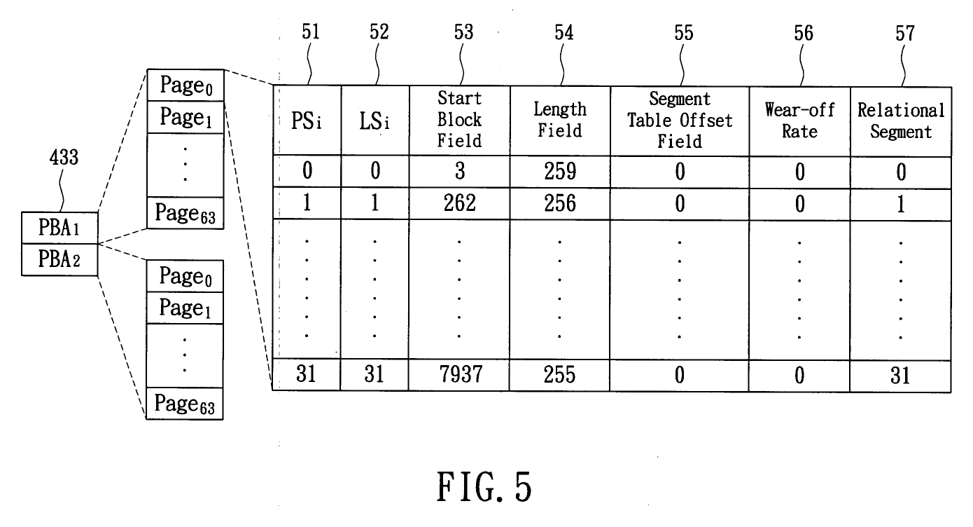

To further understand the correspondence of the logical/physical address conversion, reference can be made to FIG. 4, wherein a storage architecture diagram of an embodiment for the logical/physical segment mapping according to the present invention is shown. Relevant system architecture can be also referred conjunctively to FIG. 3. As depicted in FIG. 4, the host 31 and the high density memory unit 3311 respectively has logical storage space 41 and physical storage space 43 for data access, wherein the logical storage space 41 is divided into 32 logical segments LS₀˜LS₃₁, while the physical storage space 43 is divided into 32 physical segments PS₀˜PS₃₁ individually corresponding to the logical segments LS₀˜LS₃₁. In one embodiment, each logical segment LSᵢ is composed of 250 logical blocks, and each physical segments PSᵢ is composed of 256 physical blocks, in which 250 physical blocks are used to respectively corresponding to the logical blocks, while the rest 6 physical blocks are used as free blocks for backup purpose.

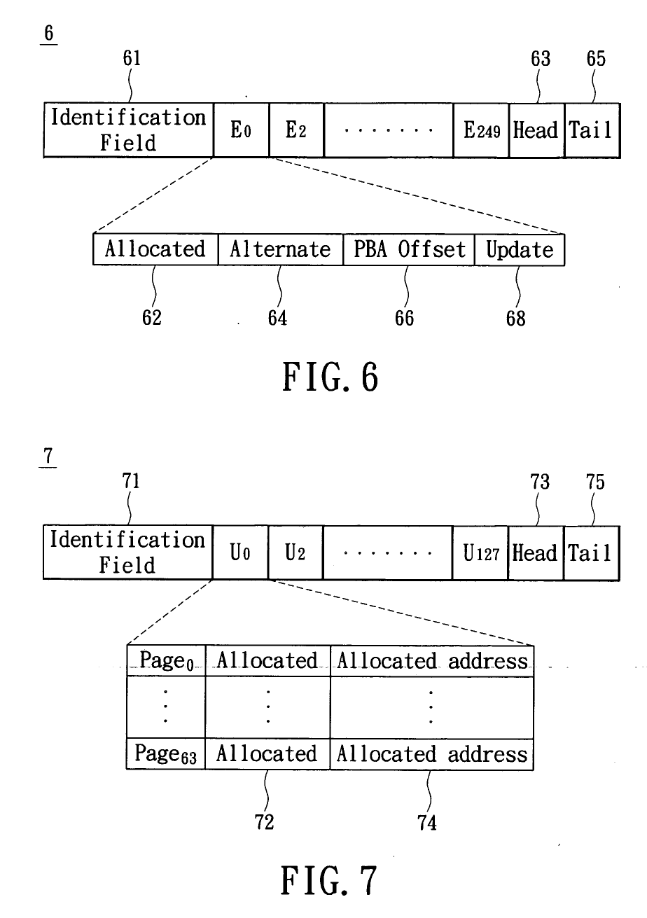

The storage module 331 further retains at least two physical blocks to individually store a boot file 431 and a master table 433. The boot file 431 records required information for startup of the memory system 33, such as firm image, vendor information and so on; meanwhile the master table 433 records the mapping relationship of the logical segment LSᵢ and the physical segment PSᵢ. Referring conjunctively to FIG. 5, an architecture diagram of an embodiment for the master table 433 according to the present invention is shown.

As illustrated in FIG. 5, the storage module 311 reserves two physical blocks PBA₁, PBA₂ to store the master table 433. The master table 433 consists of a physical segment field 51, a logical segment field 52, a start block field 53, a length field 54, a segment table offset field 55 and also records information such as wear-off rate 56, relational segment 57. The physical segment field 51 and the logical segment field 52 indicate the correspondence of each segment; in one embodiment, it is prescribed that the physical segment PSᵢ corresponds to the logical segment LSⱼ, where i=j.

The start block field 53 and the length field 54 respectively indicates the start block address and the segment length of each physical segment PSᵢ, in which the start block address and the segment length may be flexibly modified based on the status (e.g. number of bad blocks) of each physical block in the physical storage space 43, such that each physical segment PSᵢ has a certain number of free blocks.

Each physical segment PSᵢ has a Segment Table 6 indicating the correspondence between the physical block PBAᵢ included in each physical segment PSᵢ and the logical block as well as allocation information; the contents recorded in the segment table offset field 55 indicate the physical block address storing each Segment Table.

The wear-off rate field 56 records the extent of wear-off of the physical segment PSᵢ, and the control module 333 adjusts the correspondence between the physical segment PSᵢ and the logical segment LSⱼ in accordance with the extent of wear-off in the physical segment PSᵢ, and then records the adjusted information in the field of the relational segment 57.

In one embodiment of the present invention, the storage module 331 retains two physical blocks PBA₁, PBA₂ to store the master table 433, and the physical block PBA₁ is further divided into 64 physical pages Page₀˜Page₆₃. The master table 433 is initially stored in the Page₀ in the physical block PBA₁ and written in unit of the physical page Pageᵢ. When the contents of the master table 433 are updated, the updated master table 433 is sequentially stored in the Page₁ and so on, until the physical page Page₆₃ is reached, then the physical page Page₀ in the physical block PBA₂ is sequentially used to store the updated master table 433 therein and the physical block PBA₁ is erased as well; then, upon writing to the physical page Page₆₃, it turns back to use the physical block PBA₁ to store the updated master table 433. Thus, by repeating the aforementioned operations, the contents of the master table 433 can be maintained with such a cyclic storage mechanism.

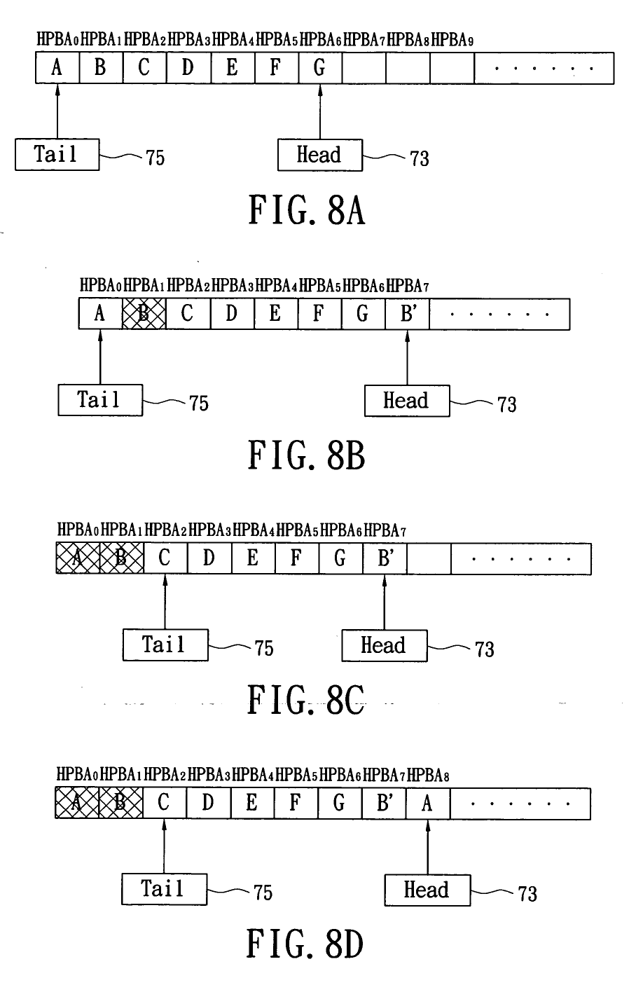

Next, refer now to FIG. 6, wherein an architecture diagram of an embodiment for the Segment Table according to the present invention is shown. Relevant system architecture thereof may be referred conjunctively to FIGS. 3 to 5. As depicted in FIG. 6, the Segment Table 6 comprises an identification field 61, a plurality of allocation information fields E₀˜E₂₄₉, a first head pointer register 63 and a first tail pointer register 65. The identification field 61 is used to examine whether the subsequent data structure is the contents recorded in the Segment Table 6. The allocation information field Eᵢ indicates the information of the logical block corresponding to the physical block, which consists of an allocated flag field 62, an alternate segment flag field 64, a PBA offset field 66 and an update field 68.

The allocated flag field 62 is used to indicate whether the physical block has been allocated to access the user data; the alternate segment flag field 64 is used to indicate whether to adjust the physical address of the user data or not, and in case that the data in the alternate segment flag field 64 is set to be 1, it means it is required to access the user data stored in another physical segment; otherwise, indicating to access the user data in the current physical segment. The PBA offset field 66 is used to indicate the physical block address for accessing the user data; the update field 68 is used to indicate the address of the user data in the low density memory unit 3313.

The first head pointer register 63 and the first tail pointer register 65 are used to instruct the allocation condition of physical blocks in any physical segment, in which data will be sequentially written in the physical block to which the first head pointer register 63 points, and also sequentially erased from the physical block to which the first tail pointer register 65 points, thereby recording data in a fashion of storage space cyclic allocation.

In a hybrid density memory system, frequently accessed and updated data (also referred as hot data) will be allocated at the low density memory to enable fast access; contrarily, less frequently used non-hot data (also referred as cold data) allocated to the high density memory. Since length of the data frequently occurring is generally shorter, in one embodiment of the present invention, the length of the user data is compared with a threshold to determine the properties of the user data; suppose the threshold is set to be 4 KB, then the user data of less than 4 KB should be allocated to the low density memory unit 3313; otherwise, it is to be allocated to the high density memory unit 3311.

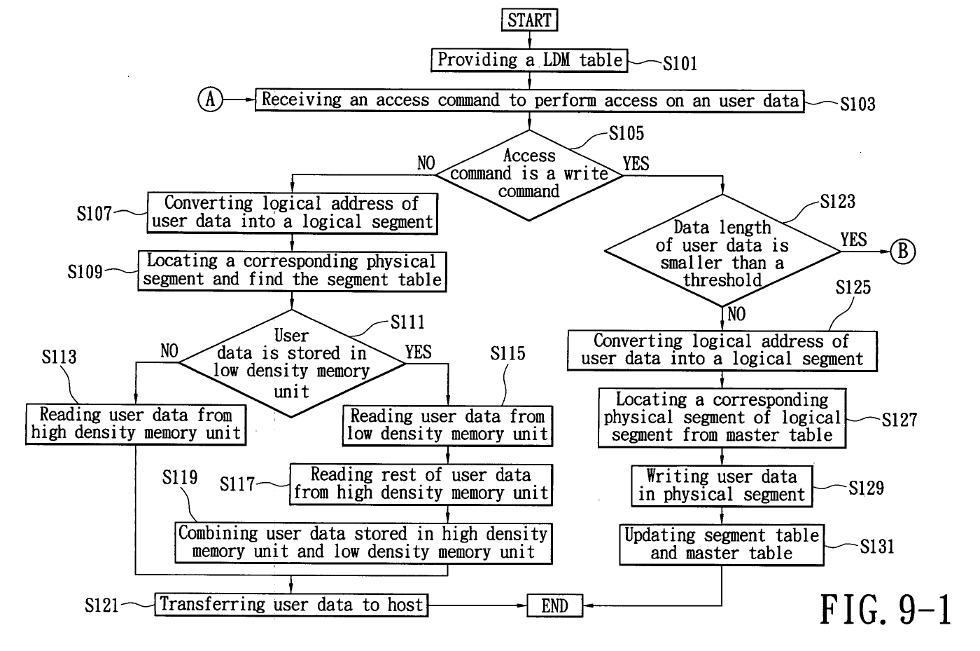

Refer now to FIG. 7, wherein an architecture diagram of an embodiment for the Low Density Memory table according to the present invention is shown. Relevant system architecture can be conjunctively referred to FIGS. 3˜6. The low density memory unit 3313 defines a plurality of consecutive hot physical blocks, with each hot physical block divided into 64 physical pages Page₀˜Page₆₃. The Low Density Memory table (LDM table) 7 is stored in one of the hot physical blocks, so as to indicate the allocation information about the storage space in the low density memory unit 3313.

As shown in FIG. 7, the LDM table 7 consists of an identification field 71, a plurality of update information fields U₀˜U₁₂₇, a second head pointer register 73 and a second tail pointer register 75. The identification field 71 is used to examine whether the subsequent data structure is the contents recorded in the LDM table 7. The update information field Uᵢ indicates the information of the logical block corresponding to the hot physical block, which includes an allocated state field 72 and an allocated address field 74. The allocated state field 72 is used to indicate whether each physical page in the hot physical block is allocated with valid user data; the allocated address field 74 is used to indicate the address of the hot physical block to which the above-said valid user data is allocated or the address in which the user data is directly stored.

In practice, suppose there is data in a physical block (128 KB in size for example), 4 KB of the said data is frequently updated, thus the frequently updated data will be allocated in at least one physical page Pageᵢ within the low density memory unit 3313 in unit of the physical page, while the rest 124 KB of less frequently updated data is still allocated in the high density memory unit 3311. Herein the allocated state field 72 storing the user data is set to be 1, and the corresponding allocated address field 74 is the physical page address storing the user data. In case that it is to read the data, it first locates the corresponding physical segment PSᵢ of the data from the master table 433, reading out the 124 KB data contents stored in the high density memory unit 3311, and then querying, from the Segment Table 6 in the physical segment PSᵢ, whether the update field 68 of the data points to any update information field Uᵢ in the LDM table 7, further finding the address allocated with the user data to read out the remaining 4 KB user data. Conversely, if the value in the update field 68 is greater than the number of update information fields Uᵢ (128 update information fields Uᵢ in the present example), it indicates that the data is entirely allocated to the high density memory unit 3311, and none is allocated to the low density memory unit 3313.

The second head pointer register 73 and the second tail pointer register 75 are used to indicate the allocation condition of the hot physical block in the low density memory unit 331, in which the data will be written sequentially in the hot physical block to which the second head pointer register 73 points and also erased sequentially from the hot physical block to which the tail pointer register 75 points, thereby recording data in a fashion of storage space cyclic allocation.

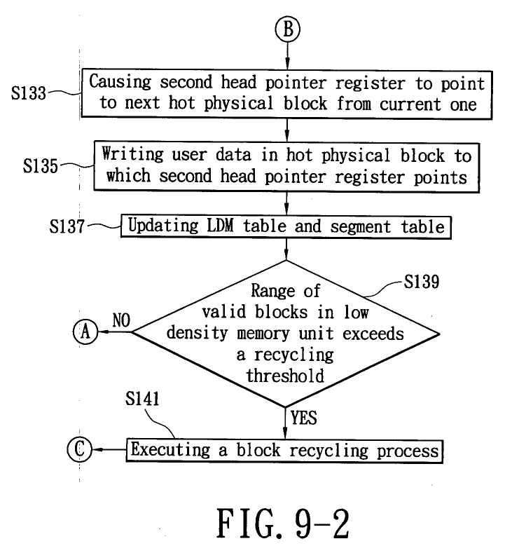

In order to further understand the way of processing the data access in the low density memory unit 3313, refer now conjunctively to FIGS. 8A˜8D, wherein diagrams of an embodiment for the data processes according to the present invention are shown. In the hot physical block provided by the low density memory unit 3313, the address stored in the second head pointer register 73 points to the hot physical block of the newest accessed user data, and the address stored in the second tail pointer register 75 points to the hot physical block of the oldest accessed user data, in which the range defined in between is the range of the physical blocks recording valid user data allocated for use in the segment. The low density memory unit 3313 can be deemed as the space for cyclic recording; new user data is sequentially written in the hot physical block to which the second head pointer register 73 points, and, as desired (directly or recycled through erasure), adjusts the hot physical block to which the second tail pointer register 75 points. When the writing reaches one end of the hot physical block (i.e. the physical block with highest or lowest address in the segment), in case that it moves again, the contents in the registers will be set once more, such that it points to the other end of the hot physical block (i.e. the physical block with lowest or highest address in the segment), thus allowing the hot physical blocks to be allocated in a cyclic, sequential way, further achieving the objective of even erasure in the memory.

As shown in FIG. 8A, the low density memory unit 3313 consists of a plurality of hot physical blocks HPBAᵢ defining a recycle threshold limiting the number of valid physical blocks; for example, it may be limited to at most 7 valid physical blocks for data recording. The valid user data A˜G is sequentially written in the hot physical blocks HPBA₀˜HPBA₆, wherein the data A in the HPBA₀ is the oldest data and the data G in the HPBA₆ the newest data; at this moment, the second tail pointer register 75 points to the HPBA₀ and the second head pointer register 73 points to the HPBA₆, thereby inferring the hot physical blocks HPBA₀˜HPBA₆ to be the range of the aforementioned valid physical blocks.

Subsequently, as shown in FIG. 8B, suppose the user data B′ of data B is to be written in, then the second head pointer register 73 points to the hot physical block HPBA₇ to allocate the user data B′ therein, and erases the hot physical block HPBA₁ originally storing the data B; however, the range of the valid physical blocks now becomes HPBA₀˜HPBA₇, which has apparently exceeded the threshold of recycling number set by the system. Hence, in order to maintain a suitable number of free blocks in each physical segment, it is required to perform a block recycling process.

As shown in FIG. 8C, the block recycling process first determines whether the data A stored in the hot physical block HPBA₀ to which the second tail pointer register 75 points has been erased; since the data A is not erased, it is to alternatively store the data A in the high density memory unit 3311, then erase the data A in the hot physical block HPBA₀ to which the second tail pointer register 75 points, and cause the second tail pointer register 75 to point to the hot physical block HPBA, and so on, thereby providing a mechanism of cyclic data allocation.

It is particularly noted that, in one embodiment of the present invention, the LDM table 7 is stored in one hot physical block HPBAᵢ and written in the hot physical block HPBAᵢ sequentially in unit of physical page, which is similar to the update mode of the master table 433; when the hot physical block HPBAᵢ is entirely filled, it will look for another available hot physical block HPBAⱼ (i≠j) to continue to write, and erase the originally stored hot physical block HPBAᵢ. As shown in FIG. 8D, if the data A is located in the LDM table 7, then, when the hot physical block HPBA₀ is entirely filled, it is necessary to alternatively place the data A to the nearest available hot physical block from behind the second head pointer register 73, causing the second head pointer register 73 to point to the hot physical block HPBA₈ and allocating the data A therein; afterward, the hot physical block HPBA₀ originally storing the data A is erased and the position to which the second tail pointer register 75 is adjusted. In practice, it is applicable to consider the contents of the LDM table 7 as user data, and place such contents in the low density memory unit 3313 along with other user data in a cyclic fashion.

Through the aforementioned concept, data and the Segment Table 6 may be also allocated sequentially and in a cyclic fashion in the high density memory unit 3311 by means of adjusting the first head pointer register 63 and the first tail pointer register 65.

The above-said threshold and recycling threshold can be user-defined settings, or determined by the memory system 33 based on the data processing conditions.

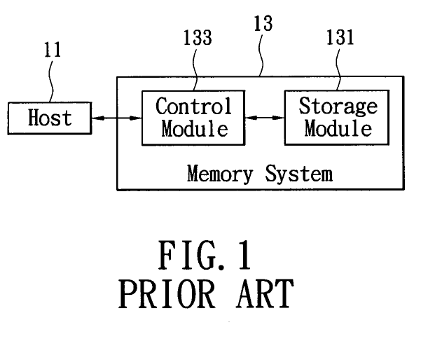

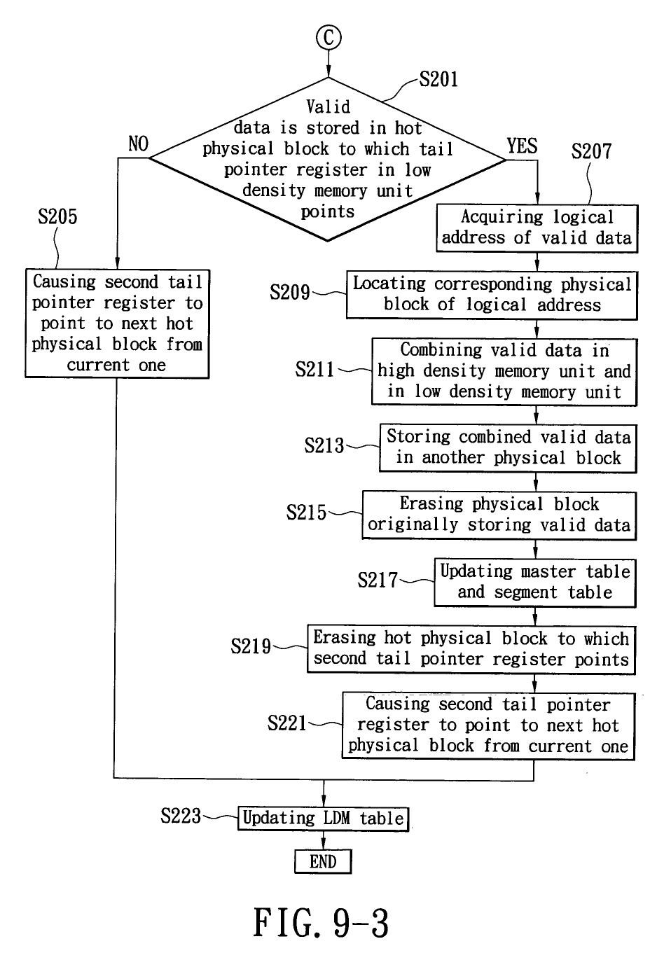

Refer now to FIGS. 9-1, 9-2, wherein a stepwise flowchart of an embodiment for the control method of the hybrid density memory system according to the present invention is shown. Herein relevant system architecture and tables can be conjunctively referred to FIGS. 3˜8. As depicted in FIG. 9-1, 9-2, the control method comprises the following steps:

initially, it provides a Low Density Memory table (LDM table) 7 in the hybrid density memory system 33 (STEP S101); upon reception of an access command to perform an access operation on a user data (STEP S103), the control module 333 first determines whether the access command is a write command (STEP S105); if no, then it indicates the access command is a read command, and converts the logical address of the user data into a logical segment (STEP S107); next, the control module 333 locates a corresponding physical segment of the acquired logical segment from the master table 433 and finds the physical block address where the Segment Table 6 of the physical segment is stored from the Segment Table offset field 55 (STEP S109);

subsequently, it determines whether the user data intended to be read is partially stored in the low density memory unit 3313 (STEP S111), which is determined through the value in the update field 68; if the value in the update field 68 is greater than 127 (not restrictive), indicating the user data is wholly stored in the high density memory unit 3311, thus the user data is read from the high density memory unit 3311 (STEP S113) and then transferred to the host 31 (STEP S121);

suppose the determination in STEP S111 is yes, then control module 333 points to any one of update information fields Uᵢ in the LDM table 7 based on the update field 68, then reads the user data from the hot physical block in the low density memory unit 3313 to which the update information fields Uᵢ points (STEP S115); and, after the rest of the user data being reading out from the high density memory unit 3311 (STEP S117), such acquired user data stored in these two densities of memories are combined (STEP S119) and finally transferred to the host 31 (STEP S121);

however, if the received access command is determined to be a write command in (STEP S105), then it determines whether the data length of the user data is smaller than a threshold (STEP S123); if not, it indicates that the user data is not hot data, which should be allocated in the high density memory unit 3311, thus first converting the logical address of the user data into the logical segment (STEP S125), and locating the corresponding physical segment of the acquired logical segment from the master table 433 (STEP S127), subsequently placing the user data in the appropriate physical block in the physical segment (STEP S129); finally, the Segment Table 6 and the master table 433 are updated based on the information adjusted during the process of the user data allocation;

if the determination in STEP S123 is yes, which indicates the user data is hot data, then the data is to be allocated in the low density memory unit 3313, thus it first causes the second head pointer register 73 to point to the next hot physical block from the current one (STEP S133), then writes the user data in the hot physical block to which the second head pointer register 73 points (STEP S135), and updates the contents of the LDM table 7 and the Segment Table 6 (STEP S137) based on the parameters modified by the aforementioned operations (e.g. the value in the second head pointer register 73); finally, it determines whether the range of the valid blocks in the low density memory unit 3313 exceeds a recycling threshold (STEP S139), if not, then continue to execute the STEPS 103 to access the next user data; otherwise, execute a block recycling process (STEPS 141).

Finally, refer to FIG. 9-3, a stepwise flowchart of an embodiment for the block recycling process applicable for the low density memory unit 3313 of the present invention, according to the present invention is shown. Herein relevant system architecture and tables can be conjunctively referred to FIGS. 3˜9-2, which control method comprising the following steps:

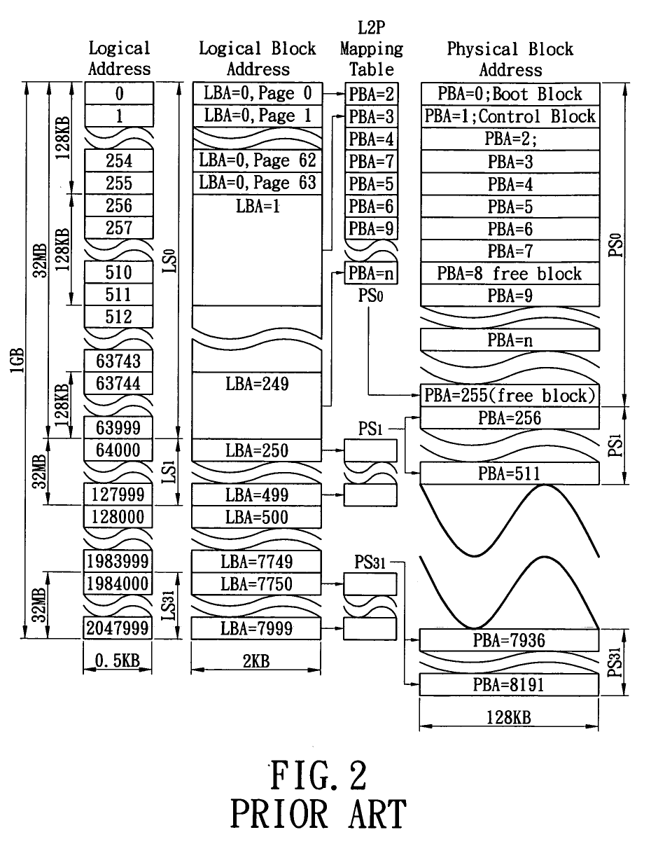

after execution of the operation flow shown in FIG. 9-2, it starts to perform the block recycling process; at this moment, the control module 333 first determines whether valid data is stored in the hot physical block to which the second tail pointer register 75 points (STEP S201); if not, indicating such a hot physical block is erasable or has been erased; then after erasure of the block, it causes the second tail pointer register 75 to point to the next hot physical block from the current (STEP S205) and updates the LDM table 7 (STEP S223) based on the parameters modified by the aforementioned operations (e.g. the value of the second tail pointer register 75);

if the determination in STEP S201 is yes, then the control module 333 locates the logical address of the valid data (STEP S207), and finds the corresponding physical block of the logical address in the high density memory unit 3311 (STEP S209), in order to acquire the address of the rest of the valid data stored in the high density memory unit 3311; subsequently, the valid data stored in the high density memory unit 3311 and in the low density memory unit 3313 is combined (STEP S211), and the combined valid data is entirely stored in another available physical block (STEP S213); next, it erases the physical block originally storing the valid data (STEP S215), and updates the Segment Table 6 and the master table 433 based on the parameters modified by the aforementioned operations (STEP S217);

finally, it erases the hot physical block to which the second tail pointer register 75 points and causes the second tail pointer register 75 to point to the next hot physical block from the current one, then updates the LDM table 7 based on the parameters modified by the aforementioned operations (STEP S223), thereby completing the method.

In this way, the frequently access portion of the data can be allocated in the low density memory unit 3313, while the rest portion thereof is alternatively stored in the high density memory unit 3311, thereby enabling data access among these two densities of memories through a series of indirect addressing operations.

With the details descriptions for the embodiments illustrated hereinbefore, it can be appreciated that the hybrid density memory system and control method thereof according to the present invention can, under the adjustable segmented memory structure, provide the data process method through the LDM table to manage the allocation of low density memory unit, so as to control the accesses of user data among different densities of memories. The present invention has the following advantages:

1. it manages the allocation position based on the properties of the user data, thereby fully exploiting the features of the two types of memories for data process, effectively improving the performance of the hybrid density memory system;

2. the user data is allocated sequentially and cyclically in the low density memory; the physical block in the high density memory adjusts the correspondence with the logical segment also based on the extent of wear-off, and data is allocated sequentially and cyclically in each physical segment as well, thereby achieving the objective of wear-leveling, effectively enhancing the lifespan of the hybrid density memory system;

3. data having not been updated for a long time in the low density memory will be re-written in the high density memory through the block recycling process, such that what stored in the low density memory is surely the most recent and most commonly employed user data, thereby, without application of algorithms like Least Recently Used (LRU) or Least Frequently Used (LFU), it can still provide efficient data processes.

The aforementioned disclosure simply sets forth the detailed descriptions and appended drawings of the embodiments according to the present invention, rather than being used to limit the present invention; the scope of the present invention should be based on the following claims, and all changes or modifications that those skilled ones in the art can conveniently consider in the field of the present invention should be deemed as being encompassed within the scope of the present invention delineated by the following claims.

What is claimed is:

1. A hybrid density memory system which is applicable to allow a host to access user data, in which the host has a storage space consisting of a plurality of logical units for accessing the user data, which hybrid density memory system comprising:
a storage module, which consists of a high density memory unit formed by high density memories and a low density memory unit formed by low density memories, wherein the high density memory unit is divided into a plurality of physical units as the storage space to facilitate one-to-one correspondence with such logical units, with each one of the physical units including a plurality of physical blocks; and
a control module, which is coupled between the host and the storage module, used to transfer user data to the high density memory unit or the low density memory unit based on the properties of the user data.

2. The hybrid density memory system according to claim 1, wherein the control module adjusts the correspondence between the addresses of the logical units and the physical units based on the number of erasures in the physical units.

3. The hybrid density memory system according to claim 1, wherein the logical unit is a logical segment, and the physical unit is a physical segment.

4. The hybrid density memory system according to claim 1, wherein the control module can define the start address and length of each of the physical units.

5. The hybrid density memory system according to claim 1, wherein each of the physical units has a Segment Table for indicating the allocation information of the physical block.

6. The hybrid density memory system according to claim 5, wherein the Segment Table has an update field for indicating the address in the low density memory unit for the user data access.

7. The hybrid density memory system according to claim 6, wherein the Segment Table has an allocated flag field indicating whether the physical block is allocated for accessing the user data, and has an alternate segment flag field indicating whether to adjust the physical address for accessing the user data, and has a PBA offset field indicating the physical block address for accessing the user data.

8. The hybrid density memory system according to claim 6, wherein the low density memory unit has a Low Density Memory table (LDM table) indicating the allocation information about the storage space of the low density memory unit, and the address of the low Density Memory table is recorded in the Segment Table.

9. The hybrid density memory system according to claim 1, wherein the storage module retains one of the physical blocks to store a boot file used to store the required information for controlling the startup of the memory system.

10. The hybrid density memory system according to claim 1, wherein the low density memory unit is Single-Level Cell (SLC) memory, Phase-Changed Memory (PCM), free Ferro-electronic Random Access Memory (FeRAM) or Magnetic Random Access Memory (MRAM); the high density memory unit is Multi-Level Cell (MLC) memory.

11. A control method for the hybrid density memory system which is applicable for user data access between a host and the hybrid density memory system, wherein the host has a plurality of logical units as the storage space to access the user data, and the hybrid density memory system has a high density memory unit and a low density memory unit, which high density memory unit providing a plurality of physical units as the storage space to one-to-one correspond to the logical units, each of the physical units including a plurality of physical blocks, which control method comprising the following steps:
providing a Low Density Memory table (LDM table) in the hybrid density memory system to record the allocation information about the storage space of the low density memory unit; and
transferring the user data to the high density memory unit or the low density memory unit based on the properties of the user data and the contents of the LDM table.

12. The control method according to claim 11, wherein the operation modes of the host include a read mode and a write mode.

13. The control method according to claim 12, wherein the low density memory unit defines a plurality of continuous hot physical blocks, in which a range of valid physical blocks is defined from the included hot physical blocks by a head pointer register and a tail pointer register, which valid physical blocks storing at least one valid data, the address stored in the head pointer register pointing to the hot physical block most recently accessing the valid data, and the address stored in the tail pointer register pointing to the hot physical block most early accessing the valid data.

14. The control method according to claim 13, wherein the user data is sequentially allocated in such physical blocks or such hot physical blocks.

15. The control method according to claim 13, wherein each of the physical units consists of a segment table for recording the allocation condition of such physical blocks and recording the address of the LDM table.

16. The control method according to claim 15, wherein, when the operation mode of the host is the read mode, the step of accessing the user data based on the properties of the user data and the contents of the LDM table further includes the following steps:
determining whether the user data is stored in the low density memory unit;
determining, based on the above-said determination, whether to locate the physical block storing the user data from the segment table or to locate the hot physical block storing the user data from the LDM table; and
reading out the user data from the correct address, and combining the user data read from the low density memory and the rest of the user data read from the high density memory to send the result back to the host.

17. The control method according to claim 15, wherein the high density memory unit and low density memory unit record the valid data, the user data and the segment table in a fashion of storage space cyclic allocation.

18. The control method according to claim 17, wherein, when the operation mode of the host is the write mode, the step of accessing the user data based on the properties of the user data and the contents of the LDM table further includes the following steps:
comparing the data length of the user data with a threshold for differentiating the properties of the user data;
if the data length of the user data is smaller than the threshold, then executing the following steps:
causing the head pointer register to point to the next hot physical block from the current one;
allocating the user data to the hot physical block to which the head pointer register points;
determining whether the range of the valid physical blocks exceeds a recycling threshold; and
if the range of the valid physical blocks exceeds the recycling threshold, then executing a block recycling process; and
if the data length of the user data is greater than the threshold, then executing the following steps:
locating the physical block available for allocating the user data from the segment table; and
accessing the user data in the physical block.

19. The control method according to claim 16, further comprising the following step:
updating the LDM table and the segment table based on the adjusted information during the user data allocation process.

20. The control method according to claim 18, further comprising the following step:
updating the LDM table and the segment table based on the adjusted information during the user data allocation process.

21. The control method according to claim 18, wherein the block recycling process consists of the following steps:
determining whether the valid data stored in the hot physical block to which the tail pointer register points has been erased;
if the valid data stored in the hot physical block to which the tail pointer register points has been erased, then the tail pointer register points to the next hot physical block from the current one; and
if one of the valid data is stored in the hot physical block to which the tail pointer register points, then executing the following steps:
locating the physical block storing the valid data from the high density memory unit;
combining the valid data stored in the high density memory unit and in the low density memory unit to write into another physical block; and
erasing the physical block originally storing the valid data and erasing the hot physical block to which the tail pointer register points.

22. The control method according to claim 21, further comprising the following step:
updating the LDM table and the segment table based on the adjusted information during the block recycling process.

23. The control method according to claim 11, wherein the correspondence between the addresses of such logical units and such physical units is adjusted based on the number of erasures in such physical units.

24. The control method according to claim 11, wherein the LDM table is stored in the low density memory unit or in the control module.
